(19) United States
(12) Patent Application Publication
(10) Pub. No.: US 2026/0341304 A1
(43) Pub. Date: Oct. 29, 2026

(54) MAGNETIC RECORDING MEDIUM, MAGNETIC RECORDING MEDIUM PRODUCTION METHOD, AND MAGNETIC STORAGE APPARATUS

(71) Applicants: Resonac Corporation, Tokyo (JP); Resonac Hard Disk Corporation, Chiba (JP)

(72) Inventors: Tatsuki OYAMA, Chiba (JP); Tomoyuki TSUYAMA, Tokyo (JP); Takayuki FUKUSHIMA, Chiba (JP); Haruhisa OHASHI, Chiba (JP); Chen XU, Chiba (JP); Kohei OCHIAI, Tokyo (JP)

(21) Appl. No.: 19/636,455

(22) Filed: Apr. 1, 2026

(30) Foreign Application Priority Data
Apr. 17, 2025 (JP) 2025-068406

(51) Int. Cl. G11B 5/66; G11B 5/82; G11B 5/851

(52) U.S. Cl. CPC G11B 5/672; G11B 5/82; G11B 5/851

(57) ABSTRACT

A magnetic recording medium is provided and includes a substrate; a first magnetic layer that includes magnetic particles having an L1₀ structure and being (001)-oriented; and a second magnetic layer that includes magnetic particles having an hcp structure and including at least Co and Pt. The first magnetic layer is stacked over the substrate, and the second magnetic layer is stacked over the first magnetic layer. Rku of a growth surface of the first magnetic layer is 5 or more, and Rku of a growth surface of the second magnetic layer is 2.5 or more and 4.0 or less.

### CROSS-REFERENCE TO RELATED APPLICATIONS

The present application is based on and claims priority to Japanese Patent Application No. 2025-068406 filed on Apr. 17, 2025, the entire contents of which are hereby incorporated by reference.

### BACKGROUND

### 1. Field of the Invention

The present disclosure relates to a magnetic recording medium, a magnetic recording medium production method, and a magnetic storage apparatus.

### 2. Description of the Related Art

A magnetic recording medium typically includes a substrate and a magnetic layer, which is stacked over the substrate. A method of recording magnetic information on the magnetic recording medium is, for example, a heat- or microwave-assisted recording method in which the magnetic recording medium is irradiated with laser light or microwaves to locally reduce the coercive force. Since these assisted recording methods can achieve a high areal recording density of 2 Tbit/inch² class, the assisted recording methods are considered as next-generation recording methods that can increase the storage capacity in response to size reduction and increased recording density of the magnetic recording medium.

In such assisted recording methods, a magnetic recording medium having a magnetic layer with a coercive force of several tens of kOe at room temperature can be used, thereby allowing magnetic particles having a high crystalline magnetic anisotropy constant (Ku) to be used in the magnetic layer. Known magnetic particles having a high Ku are magnetic particles having an L1₀ structure, such as, for example, FePt alloy particles having a Ku of about 7×10⁶ J/m³, and CoPt alloy particles having a Ku of about 5×10⁶ J/m³.

A disclosed magnetic recording medium that includes a magnetic layer including magnetic particles having an L1₀ structure is, for example, a magnetic recording medium that includes a magnetic layer including, as a main component, FePt or CoPt particles having an L1₀ structure being (001)-oriented, in which the magnetic layer is disposed over a plurality of underlayers, such as an MgO underlayer or the like, formed over a substrate (see, for example, Japanese Laid-Open Patent Application Publication No. 2016-26368).

Also, it is reported that FePt particles on MgO have facets of (111) planes appearing on their side surfaces (see, for example, Jinyu Deng et al., “Lattice-Mismatch-Induced Oscillatory Feature Size and Its Impact on the Physical Limitation of Grain Size” Physical Review Applied, Volume 9, Issue 3, 034023, 23 Mar. 2018).

### SUMMARY

The present disclosure provides the following.
[1] A magnetic recording medium, including:
a substrate;
a first magnetic layer that includes magnetic particles having an L1₀ structure and being (001)-oriented; and
a second magnetic layer that includes magnetic particles having an hcp structure and including at least Co and Pt,
the first magnetic layer being stacked over the substrate, and the second magnetic layer being stacked over the first magnetic layer, wherein
Rku of a growth surface of the first magnetic layer is 5 or more, and
Rku of a growth surface of the second magnetic layer is 2.5 or more and 4.0 or less.
[2] The magnetic recording medium according to [1], wherein a particle diameter of the magnetic particles included in the first magnetic layer is 10 nm or less.
[3] A magnetic recording medium production method, including:
forming a first magnetic layer over a substrate with a growth surface being a (001) plane, a (111) plane, and an equivalent plane of the (111) plane, in which the first magnetic layer includes magnetic particles having an L1₀ structure and being (001)-oriented, and Rku of the growth surface is set to be 5 or more; forming a magnetic film over the first magnetic layer, in which the magnetic film includes magnetic particles having an hcp structure and including at least Co and Pt; and
ion milling a surface of the magnetic film to form a second magnetic layer in which Rku is 2.5 or more and 4 or less.
[4] The magnetic recording medium production method according to [3], wherein the ion milling uses a noble gas having an atomic weight that is greater than an atomic weight of Ar.
[5] A magnetic storage apparatus, including:
the magnetic recording medium of [1] or [2].

### BRIEF DESCRIPTION OF THE DRAWINGS

FIG. 1 is a schematic diagram illustrating an example of a crystal plane of a magnetic particle having an L1₀ structure and being (001)-oriented.

FIG. 2 is a diagram illustrating an example of a layer configuration of a magnetic recording medium according to an embodiment of the present disclosure.

FIG. 3 is a perspective diagram illustrating an example of a magnetic storage apparatus using the magnetic recording medium according to the embodiment of the present disclosure.

FIG. 4 is a schematic diagram illustrating an example of a magnetic head.

### DETAILED DESCRIPTION OF THE DISCLOSURE

When writing information on magnetic particles forming a magnetic layer of the magnetic recording medium, since the magnetic layer is magnetized in units of the magnetic particles, it is desired to micronize the magnetic particles in order to increase the recording density of the magnetic recording medium. In the magnetic layer, the nucleation density of the magnetic particles is high in the initial stage of growth, but after the middle stage of growth, the magnetic particles are bonded to each other to reduce the nucleation density and increase the crystal particle diameter, resulting in coarsening of the magnetic particles.

The coarsening of the magnetic particles causes a reduction in the recording density of the magnetic recording medium. Whereas, when the magnetic particles are micronized to increase the recording density of the magnetic recording medium, RKu of the growth surface of the magnetic layer increases. As the RKu of the growth surface of the magnetic layer increases, a protective layer formed over the surface of the magnetic layer tends to be scraped, and the adhesion between the magnetic layer and the protective layer also decreases. Thus, the surface of the magnetic layer tends to be corroded. Therefore, there is a need for a magnetic recording medium including a magnetic layer in which the magnetic particles included in the magnetic layer are micronized to suppress a reduction in corrosion resistance while increasing the recording density of the magnetic layer.

It is an object of the present disclosure to increase recording density and enhance corrosion resistance.

Hereinafter, embodiments of the present disclosure will be described in detail. For facilitating understanding of the description, the same components in the drawings are indicated by the same signs, and duplicate descriptions thereof are omitted. Also, dimensional proportions of the components in the drawings are not necessarily the same as in reality. In the present specification, a numerical range indicated by “A to B” refers to a numerical range including a lower limit “A” and an upper limit “B”, unless otherwise specified. In the numerical range indicated by “A to B”, when only the upper limit A is indicated in units, the lower limit B is indicated in the same units.

A magnetic recording medium according to an embodiment of the present disclosure (hereinafter may be referred to simply as “the present embodiment”) includes a substrate, a first magnetic layer that includes magnetic particles having an L1₀ structure and being (001)-oriented, a second magnetic layer that includes magnetic particles having an hcp structure and including at least Co and Pt, in which the first magnetic layer is stacked over the substrate, and the second magnetic layer is stacked over the first magnetic layer. In the magnetic recording medium according to the present embodiment, Rku of a growth surface of the first magnetic layer is 5 or more, and Rku of a growth surface of the second magnetic layer is 2.5 or more and 4.0 or less.

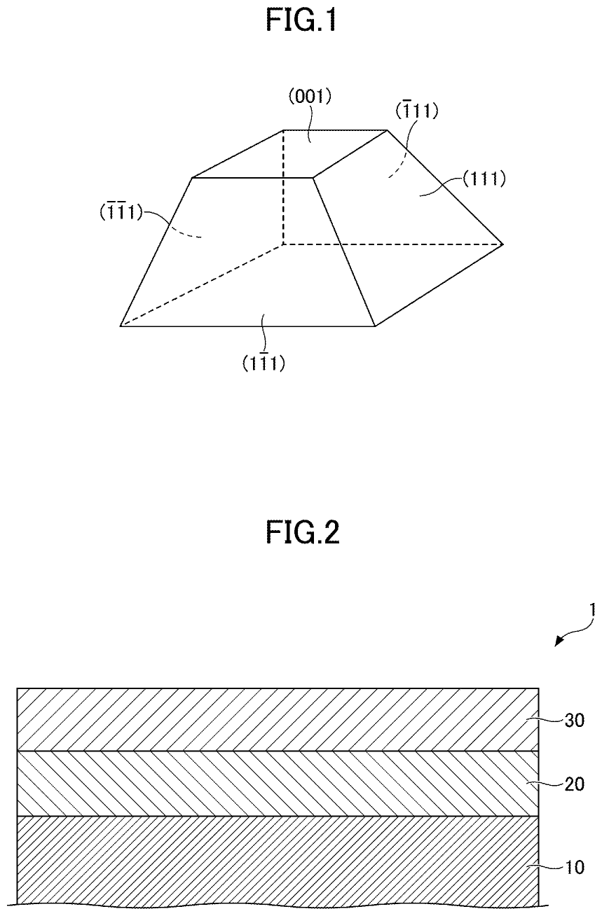

FIG. 1 is a schematic diagram illustrating an example of a crystal plane of a magnetic particle having the L1₀ structure and being (001)-oriented. As illustrated in FIG. 1, the magnetic particle having the L1₀ structure and being (001)-oriented is, for example, a square frustum-shaped crystal formed by a (001) plane and four planes, which are a (111) plane and its equivalent planes, i.e., a (−111) plane, a (1-11) plane, and a (−1-11) plane. This crystal has a square frustum shape when grown such that the (001) plane is lost, or is a flat crystal of only the square (001) plane when grown such that the (111) plane is lost.

The present inventors evaluated the growth surface of a polycrystalline magnetic layer including magnetic particles having the L1₀ structure and being (001)-oriented, in terms of kurtosis (hereinafter referred to as “Rku”), and studied the relationship between the Rku of the growth surface of the magnetic layer and coarsening of the magnetic particles. As a result, the present inventors found that the coarsening of the magnetic particles forming the magnetic layer can be reduced by setting the Rku of the growth surface of the magnetic layer to be 5 or more. Here, the Rku is one of the indices capable of statistically evaluating the surface shape of a material, and especially indicates kurtosis of the surface of the material. Specifically, when the Rku is 3, the surface has a shape close to a normal distribution, when the Rku is more than 3, the surface has a sharp peak and a deep recess around the peak, and when the Rku is less than 3, the surface is smooth and flat.

That is, when the Rku of the growth surface of the magnetic layer is 5 or more, the (111) plane and its equivalent planes on the growth surface are larger, resulting in increasing the distance between the adjacent magnetic particle and the (001) plane. This suppresses bonding between the (001) planes of the adjacent magnetic particles. When the Rku of the growth surface of the magnetic layer is less than 5, the (111) plane and its equivalent planes on the growth surface are smaller, resulting in reducing the distance between the adjacent magnetic particle and the (001) plane. This causes the (001) planes of the adjacent magnetic particles to bond to each other, and thus the magnetic particles tend to coarsen.

However, when the Rku of the growth surface of the magnetic layer is 5 or more, the growth surface has a large extent of irregularities, resulting in deterioration in surface flatness of the magnetic recording medium. This reduces flying stability of a magnetic head, resulting in deterioration in electromagnetic conversion characteristics.

The present inventors attempted to lower the Rku of the growth surface by ion milling the surface of the magnetic layer in which the Rku of the growth surface is set to be 5 or more. However, ion milling the magnetic film surface of a polycrystal, having the L1₀ structure and being (001)-oriented, collapsed the L1₀ structure into an A1 structure, resulting in deterioration in magnetic characteristics of the magnetic film. Also, specific magnetic particles were scraped, and magnetic particles around those specific magnetic particles were coarsened, resulting in deterioration in the arithmetic mean roughness Ra and in the particle size distribution of the magnetic particles.

In view of this, the present inventors conducted studies on covering the surface of the magnetic layer of the polycrystalline, having the L1₀ structure and being (001)-oriented, by a magnetic layer including magnetic particles having an hcp structure and including at least Co and Pt, followed by ion milling the surface of this magnetic layer. As a result, the present inventors could lower the Rku without collapsing the hcp structure of the magnetic layer and without deteriorating the arithmetic mean roughness Ra. Then, the present inventors found that the deterioration in the electromagnetic conversion characteristics of the magnetic recording medium could be suppressed by setting the Rku to be 2.5 or more and 4.0 or less. That is, the Rku of the magnetic layer having the hcp structure before ion milling was 5 or less, similar to that of the magnetic layer having the L1₀ structure, and the arithmetic mean roughness Ra was substantially the same as that of the magnetic layer having the L1₀ structure. However, the Rku of the magnetic layer having the hcp structure after ion milling could be selectively lowered without deteriorating the arithmetic mean roughness Ra. This is likely because ion milling of the surface of the magnetic layer preferentially rounded projections having high kurtosis on the surface of the magnetic layer having the hcp structure.

Therefore, the magnetic recording medium according to the present embodiment can include the first magnetic layer and the second magnetic layer including further micronized magnetic particles.

### <Magnetic Recording Medium>

The magnetic recording medium according to the present embodiment will be described with reference to FIG. 2. As illustrated in FIG. 2, a magnetic recording medium 1 according to the present embodiment includes: a substrate 10; a first magnetic layer 20 that includes magnetic particles having the L1₀ structure and being (001)-oriented; and a second magnetic layer 30 that includes magnetic particles having an hcp structure and including at least Co and Pt. The first magnetic layer 20 is stacked over the substrate 10, and the second magnetic layer 30 is stacked over the first magnetic layer 20. In the magnetic recording medium 1, the Rku of the growth surface of the first magnetic layer 20 is set to be 5 or more, and the Rku of the growth surface of the second magnetic layer 30 is set to be 2.5 or more and 4.0 or less.

The magnetic recording medium 1 having the above configuration can include the magnetic particles of the first magnetic layer 20 in a further micronized state, thereby further increasing the recording density. In addition, the magnetic recording medium 1 can prevent scraping of a protective layer formed over the surface of the second magnetic layer 30, thereby enhancing the adhesion between the second magnetic layer 30 and the protective layer, and hence the corrosion resistance of the surface of the second magnetic layer 30.

As described above, the first magnetic layer 20 is a layer that includes magnetic particles having the L1₀ structure and being (001)-oriented, and the Rku of the growth surface of the first magnetic layer is 5 or more. The first magnetic layer 20 is grown such that the magnetic particles are (001)-oriented, and are grown to have the (001) plane, the (111) plane, and its equivalent planes, as the growth surfaces.

As described above, when growing the magnetic particles having the L1₀ structure to have the (001) plane and the (111) plane, the resulting magnetic particles are square frustum-shaped crystals, and the (−111) plane, the (1-11) plane, and the (−1-11) plane are formed as equivalent planes of the (111) plane. Here, when the crystal of the magnetic particles is grown such that the (001) plane is lost, the resulting crystal is a square frustum-shaped crystal, and when the crystal of the magnetic particles is grown such that the (111) plane is lost, the resulting crystal is a flat crystal of only the square (001) plane. For example, when using an FePt alloy as the magnetic particles having the L1₀ structure, crystal growth performed such that the (001) plane is lost yields a square frustum-shaped crystal having four isosceles triangles with a base angle of 53° and an apex angle of 74°.

In the present embodiment, by controlling film-forming conditions of the first magnetic layer 20, it is possible to change the area ratio between the (001) plane, and the (111) plane and its equivalent planes in the growth surface. Thus, the Rku of the growth surface of the first magnetic layer 20 can be set to be 5 or more. Here, as the area ratio of the (111) plane and its equivalent planes to the (001) plane increases, the Rku increases. Although a publicly known method can be used for the film formation of the first magnetic layer 20, it is particularly preferable to use sputtering. The film-forming conditions to be controlled in this case include a substrate temperature, a gas species used for sputtering, a film-forming gas pressure, a film-forming rate, an input power, and the like.

The Rku of the growth surface of the first magnetic layer 20 can be calculated in accordance with Japanese Industrial Standard JIS B0601:2001. For example, the Rku of the growth surface of the first magnetic layer 20 can be calculated by observing a cross section of the magnetic recording medium 1 with a transmission electron microscope (TEM). In the production process of the magnetic recording medium 1, the Rku can be calculated by taking out a sample after formation of the first magnetic layer 20 and measuring the surface of the sample using a surface analyzer, such as an AFM (atomic force microscope) or the like. The Rku of the growth surface of the first magnetic layer 20 is measured in a desired number (e.g., several tens to several hundreds) by the surface analyzer, and the average value of the measured values is defined as the Rku of the growth surface of the first magnetic layer 20.

The first magnetic layer 20 may have a granular structure in which the magnetic particles and their surroundings are nonmagnetic grain boundaries. The first magnetic layer 20 may have a multilayered structure, and the volume ratio of the grain boundaries in the first magnetic layer 20 may be gradually changed.

The first magnetic layer 20 includes the magnetic particles having the L1₀ structure. Examples of the magnetic particles having the L1₀ structure include FePt alloy particles, CoPt alloy particles, and the like.

The particle diameter of the magnetic particles included in the first magnetic layer 20 is preferably 3 nanometers (nm) or more and 10 nm or less. The particle diameter of the magnetic particles is more preferably 8 nm or less, and more preferably 7.5 nm or less.

The particle diameter of the magnetic particles is the average particle diameter of the magnetic particles. The particle diameter of the magnetic particles can be measured by observing a flat surface of the magnetic particles with a transmission electron microscope (TEM). Specifically, a desired number (e.g., several tens to several hundreds) of the magnetic particles are observed with a TEM, thereby determining the areas of the magnetic particles. Then, the average value of the diameters of true circles having the determined areas is defined as the particle diameter of the magnetic particles.

The distance between the magnetic particles is preferably 4 nm or more and 12 nm or less, and more preferably 5 nm or more and 9 nm or less. The distance between the magnetic particles refers to a distance between centroids of adjacent magnetic particles. The distance between the magnetic particles can be measured by observing a flat surface with a TEM.

Further, the first magnetic layer 20 may have a granular structure including grain boundaries.

When the first magnetic layer 20 has a granular structure, the amount of the grain boundaries in the first magnetic layer 20 is preferably 25% by volume or more and 50% by volume or less, more preferably 35% by volume or more and 45% by volume or less. When the amount of the grain boundaries in the first magnetic layer 20 is in the above preferrable range, it is possible to enhance the anisotropy of the magnetic particles included in the first magnetic layer 20.

Here, the grain boundaries may include carbide, nitride, oxide, boride, or the like. Specific examples include BN, B₄C, C, MoO₃, GeO₂, and the like.

The magnetic particles are c-axis oriented, i.e., (001)-oriented, relative to the substrate 10.

The thickness of the first magnetic layer 20 is preferably 8 nm or more and 20 nm or less, more preferably 10 nm or more and 18 nm or less, and further preferably 10 nm or more and 15 nm or less. When the thickness of the first magnetic layer 20 is in the above preferrable range, a higher recording density of the magnetic recording medium 1 can be achieved.

In the present specification, the thickness of the first magnetic layer 20 refers to a length in a direction perpendicular to the main surface of the first magnetic layer 20. The thickness of the first magnetic layer 20 is, for example, a thickness measured at a desired location in a cross section of the first magnetic layer 20. When the thickness of the first magnetic layer 20 is measured at several desired locations in the cross section of the first magnetic layer 20, an average value of the measured thicknesses at these locations may be used. In the following, the measurement method that is the same as that for the thickness of the first magnetic layer 20 may be used for other layers.

The first magnetic layer 20 may include a single magnetic layer, or may include a plurality of magnetic layers that are stacked. When the first magnetic layer 20 includes a plurality of magnetic layers, the magnetic layers may be formed by using the same material or different materials. Also, a nonmagnetic layer may be included between the magnetic layers. The nonmagnetic layer may be formed using a typical material used for a magnetic recording medium.

As described above, the second magnetic layer 30 is a layer that includes the magnetic particles having the hcp structure and including at least Co and Pt, and the Rku of the growth surface of the second magnetic layer 30 is 2.5 or more and 4 or less.

Although a typical film-forming method may be used for the film formation of the second magnetic layer 30, it is particularly preferable to use sputtering.

Here, since the Rku of the growth surface of the first magnetic layer 20 is 5 or more, the Rku of the growth surface of the second magnetic layer 30 is typically close to this value. In the present embodiment, the second magnetic layer 30, in which the Rku is 2.5 or more and 4 or less, is formed by forming, over the first magnetic layer 20, a magnetic film that includes magnetic particles having the hcp structure and including at least Co and Pt, followed by ion milling of the surface of the magnetic film.

Ion milling is a method of etching a solid surface by irradiating the surface with a high-energy ion beam to physically remove surface atoms. When using ion milling, a noble gas, such as argon (Ar) or the like, is typically ionized, the formed ions are accelerated under a high voltage and applied to the surface of the first magnetic layer 20. Examples of gases used for ion milling include, in addition to Ar, helium (He), neon (Ne), krypton (Kr), xenon (Xe), radon (Rn), and the like. Further, as examples of other gases, oxygen, nitrogen, or the like may be used, or a mixture of a plurality of gases may be used.

In ion milling for forming the second magnetic layer 30, it is preferable to use a noble gas having an atomic weight that is greater than the atomic weight of Ar. This is because the Co atom included in the second magnetic layer 30 can be efficiently ion-milled by using a noble gas having an atomic weight that is greater than the atomic weight of Co, i.e., Kr, Xe, or Rn, which has an atomic weight that is greater than the atomic weight of Ar.

Further, the noble gas having an atomic weight that is greater than the atomic weight of Ar has a large atomic radius, and thus is considered to preferentially impact to the projections of the magnetic film having high kurtosis. This can efficiently lower the Rku without deteriorating the arithmetic mean roughness Ra of the surface of the magnetic film.

Examples of materials forming the magnetic film, which includes the magnetic particles having the hcp structure and including at least Co and Pt, include CoCrPt-based materials, CoCrPtB-based materials, CoCrPtTa-based materials, CoCrPtTi-based materials, CoCrPtZr-based materials, CoCrPtAl-based materials, CoCrPtSi-based materials, and the like.

The RKu of the surface of the second magnetic layer 30 is preferably closer to 3, which is given by the normal distribution. For example, the Rku is preferably 2.5 or more and 4 or less. The RKu of the surface of the second magnetic layer 30 is more preferably 2.5 or more and 3.5 or less, and further preferably 2.5 or more and 2.8 or less. When the Rku of the surface of the second magnetic layer 30 is 2.5 or more and 4 or less, the protective layer formed over the surface of the second magnetic layer 30 is not readily scraped, thereby maintaining the adhesion. Thus, it is possible to suppress failures, such as corrosion or the like, occurring on the surface of the second magnetic layer 30.

The arithmetic mean roughness Ra of the growth surface of the second magnetic layer 30 can be calculated in accordance with Japanese Industrial Standard JIS B0601:2001. The Rku of the growth surface of the second magnetic layer 30 can be calculated in the same manner as calculating the Rku of the growth surface of the first magnetic layer 20.

The substrate 10 may be a substrate typically used for magnetic recording media. Preferably, the substrate 10 is, for example, a heat-resistant glass substrate having a softening temperature of 500 degrees Celsius (°C) or higher, and preferably 600 °C or higher. The substrate 10 may be heated to a temperature of 500 °C or higher when producing the magnetic recording medium 1, but the heat-resistant glass substrate can be retained even when heated to 500 °C or higher.

An underlayer may be provided between the substrate 10 and the first magnetic layer 20.

Preferably, the underlayer includes a layer including MgO, and the magnetic particles having the L1₀ structure included in the first magnetic layer 20 are (001)-oriented. Alternatively, the underlayer may be a multilayered structure including other layers.

The underlayer preferably includes a NaCl-type compound. Examples of the NaCl-type compound other than MgO include TiO, NiO, TiN, TaN, HfN, NbN, ZrC, HfC, TaC, NbC, TiC, and the like. These may be used alone or in combination.

The magnetic recording medium 1 may further include a protective layer over the first magnetic layer 20.

The protective layer is, for example, a hard carbon film.

A method of forming the protective layer is, for example, an RF-CVD (Radio Frequency-Chemical Vapor Deposition) method in which a hydrocarbon gas (source gas) is decomposed by a radio frequency plasma to form a film, an IBD (Ion Beam Deposition) method in which a source gas is ionized by electrons emitted from filaments to form a film, or an FCVA (Filtered Cathodic Vacuum Arc) method in which a solid carbon target is used to form a film without using a source gas.

The thickness of the protective layer is preferably 1 nm or more and 6 nm or less. When the thickness of the protective layer is 1 nm or more, flying characteristics of the magnetic head are good, while when the thickness of the protective layer is 6 nm or less, the magnetic spacing is reduced to increase the SNR (signal/noise ratio (S/N ratio)) of the magnetic recording medium 1.

The magnetic recording medium 1 may further include a lubricant layer over the protective layer.

The lubricant layer may be formed by a layer of a liquid lubricant. The liquid lubricant that is suitably used is a liquid lubricant having chemical stability, low friction, and low adsorption. Examples of the liquid lubricant include, for example, fluororesin-based lubricants, such as perfluoropolyether-based lubricants including compounds having a perfluoropolyether structure.

The thickness of the lubricant layer may be, for example, 1 nm or more and 3 nm or less.

In addition to the protective layer and the lubricant layer, the magnetic recording medium 1 may include an optional layer as appropriate. For example, if necessary, the magnetic recording medium 1 may include an adhesion layer, a soft magnetic underlayer, an orientation control layer, a heat sink layer, or the like between the substrate 10 and the first magnetic layer 20, as appropriate. The soft magnetic underlayer may include, for example, a first soft magnetic layer, an intermediate layer, and a second soft magnetic layer. The orientation control layer may be a single layer, or may be two or more layers (e.g., a first orientation control layer and a second orientation control layer). The materials forming the adhesion layer, the soft magnetic underlayer, the orientation control layer, and the like may be materials that are typically used for magnetic recording media.

### <Magnetic Storage Apparatus>

A magnetic storage device including the magnetic recording medium according to the present embodiment will be described. No particular limitation is imposed on the form of the magnetic storage apparatus according to the present embodiment, as long as the magnetic storage apparatus includes the magnetic recording medium according to the present embodiment. Here, a case in which the magnetic storage apparatus records magnetic information on the magnetic recording medium using a heat-assisted recording method will be described.

The magnetic storage apparatus according to the present embodiment may include, for example, a magnetic recording medium driver configured to rotate the magnetic recording medium according to the present embodiment, a magnetic head including a near-field light transducer provided at its tip, a magnetic head driver configured to move the magnetic head, and a recording/reproducing signal processor.

The magnetic head is a heat-assisted recording type magnetic head, and includes, for example, a laser light emitter configured to emit laser light to heat the magnetic recording medium, and a waveguide configured to guide the laser light emitted from the laser light emitter to a near-field light transducer.

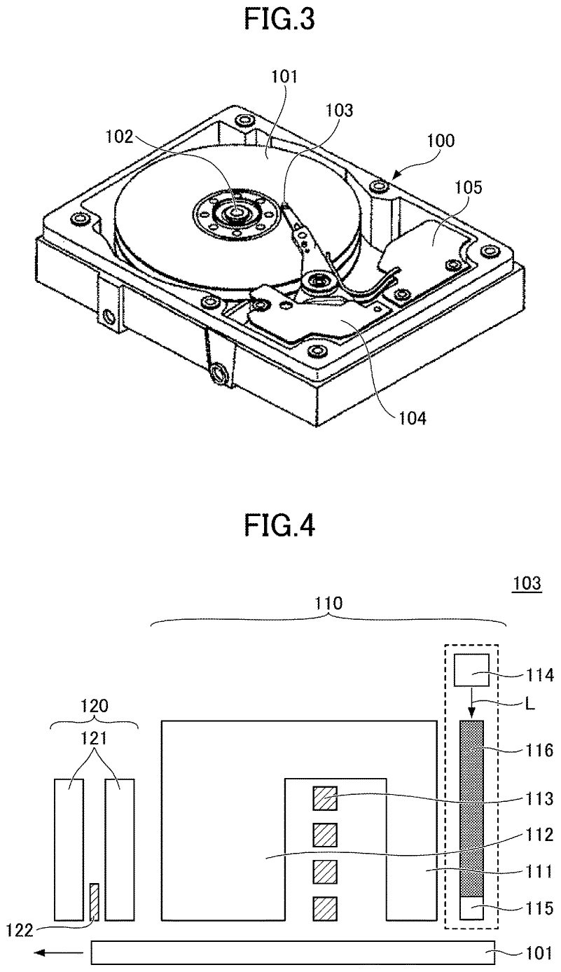

FIG. 3 is a perspective diagram illustrating an example of the magnetic storage apparatus using the magnetic recording medium according to the present embodiment. As illustrated in FIG. 3, a magnetic storage apparatus 100 includes a magnetic recording medium 101, a magnetic recording medium driver 102 configured to rotate the magnetic recording medium 101, a magnetic head 103 including a near-field light transducer at its tip, a magnetic head driver 104 configured to move the magnetic head 103, and a recording/reproducing signal processor 105. The magnetic recording medium 1 according to the present embodiment described above is used as the magnetic recording medium 101.

FIG. 4 is a schematic diagram illustrating an example of the magnetic head 103. As illustrated in FIG. 4, the magnetic head 103 includes a recording head 110 and a reproducing head 120.

The recording head 110 includes a main pole 111, an auxiliary pole 112, a coil 113 configured to generate a magnetic field, a laser diode (LD) 114 serving as a laser light emitter, and a waveguide 116 configured to transmit laser light L emitted from the LD 114 to a near-field light transducer 115.

The reproducing head 120 includes shields 121, and a read element 122 sandwiched between the shields 121.

As illustrated in FIG. 3, in the magnetic storage apparatus 100, the center portion of the magnetic recording medium 101 is attached to the rotating shaft of a spindle motor, and information is written on or read from the magnetic recording medium 101 while the magnetic head 103 flies over the surface of the magnetic recording medium 101 rotated by the spindle motor.

The magnetic storage apparatus 100 according to the present embodiment, using the magnetic recording medium 1 according to the present embodiment as the magnetic recording medium 101, enables the magnetic recording medium 101 to be increased in recording density, thereby increasing the recording density.

The magnetic storage apparatus may use a microwave-assisted magnetic recording head as the magnetic head 103, instead of the heat-assisted magnetic recording head.

Although the embodiments have been described above, the above embodiments are presented as examples, and the present invention is not limited to the above embodiments. The above embodiments can be practiced in various other forms, and various combinations, omissions, substitutions, alterations, or the like can be made without departing from the intent of the present invention. The above embodiments and variations thereof are included in the scope or intent of the present invention, and are included in the scope of equivalents of the present invention recited in claims.

### EXAMPLES

Hereinafter, the embodiments will be described in more detail by way of Examples and Comparative Examples. However, the embodiments are not limited to these Examples and Comparative Examples.

### <Production of Magnetic Recording Medium>

### Example 1

An underlayer was formed over an MgO single crystal substrate with a (100) plane exposed. As the underlayer, a 100 nm-thick Cr-50 at % Ti alloy layer and a 30 nm-thick Co-27 at % Fe-5 at % Zr-5 at % B alloy layer were sequentially formed. Next, after heating the substrate to 250 °C, a 10 nm-thick Cr layer and a 5 nm-thick MgO—C layer were sequentially formed.

Next, after heating the substrate to 450 °C, as the first magnetic layer including magnetic particles having the L1₀ structure and being (001)-oriented, a 1 nm-thick FePt-40 mol % C film was formed. Subsequently, the substrate was annealed at 650 °C for 20 seconds in a high vacuum of 10⁻⁵ Pa. Next, a 2 nm-thick FePt-40 mol % C film, a 3 nm-thick FePt-16SiO₂ film, and a 2 nm-thick FePt-25BN film were sequentially formed. The substrate was annealed at 550 °C for 20 seconds at 3 Pa, and then a 5 nm-thick FePt-16SiO₂ film was formed. The Rku of the surface of the first magnetic layer was 5.8, and the arithmetic mean roughness Ra was 0.33 nm.

Next, a second magnetic layer having an hcp structure was formed by forming a 2 nm-thick 56 at % Co-10 at % Cr-20 at % Pt-14 at % B magnetic film, followed by ion milling the surface of the magnetic film. The ion-milling conditions were that: the type of ions was Kr; the gas pressure was 0.8 Pa; the substrate temperature was 150 °C; the etching rate was 0.02 nm/second; the etching time was 6 seconds; and the beam angle was vertical (0 degrees). The Rku of the surface of the second magnetic layer after the ion milling was 3.0, and the arithmetic mean roughness Ra was 0.25 nm.

Subsequently, a 3 nm-thick carbon film was formed as a protective layer over the second magnetic layer. Subsequently, a lubricant layer of perfluoropolyether was formed over the protective layer through dipping. Thus, a magnetic recording medium was obtained.

As conditions for producing the magnetic recording medium, the particle diameter of the magnetic particles included in the first magnetic layer and the Rku and the arithmetic mean roughness Ra of the first magnetic layer, the conditions for ion milling the surface of the magnetic film used for forming the second magnetic layer (ion, etching rate, and etching time), and the Rku and the arithmetic mean roughness Ra of the second magnetic layer are shown in Table 1.

### Examples 2 to 5 and Comparative Examples 1 to 10

Magnetic recording media were produced in the same manner as in Example 1, except that, unlike in Example 1, the conditions for producing the magnetic recording medium were changed as shown in Table 1. Table 1 shows the conditions for producing the magnetic recording medium of each of the Examples and Comparative Examples. In Table 1, portions outside the scope of the present embodiment are shown in bold and italic.

### <Evaluation of Corrosion Resistance>

The corrosion resistance of the produced magnetic recording medium of each of the Examples and Comparative Examples was evaluated. The corrosion resistance of the produced magnetic recording medium was measured in the following manner. Specifically, a 3% aqueous nitric acid solution was dropped at five locations (100 microliters/location) on the surface of the magnetic recording medium, and pure water was dropped at five locations (100 microliters/location) on the surface of the magnetic recording medium. The magnetic recording medium was left to stand still for one hour and then recovered. Using an ICP mass spectrometer (7700 ICP-MS, obtained from Agilent Technologies, Inc.), the amount of Co included in the magnetic recording medium was measured through ICP-MS (Inductively Coupled Plasma Mass Spectrometry). When the amount of Co was 50 μg/surface or less, the corrosion resistance was evaluated to be good because the adhesion of Co to the magnetic head was suppressed and thus the flying of the head was not inhibited. The measurement results of the Examples and Comparative Examples are shown in Table 1.

### <Evaluation of Electromagnetic Conversion Characteristics>

Using a read/write analyzer (RWA1632, obtained from GUZIK Co.) and a spin stand (S1701MP, obtained from GUZIK Co.), an SNR (signal/noise ratio (S/N ratio)) was evaluated as the recording/reproducing characteristics of the produced magnetic recording medium of each of the Examples and Comparative Examples. When the SNR was 11 dB or more, the electromagnetic conversion characteristics were evaluated to be good. Table 1 shows the measurement results of the Examples and Comparative Examples.

TABLE 1

| | | | | Magnetic film | | | | | Corrosion | |
|---|---|---|---|---|---|---|---|---|---|---|
| | First magnetic layer | | | Conditions for ion milling | | | | | resistance | |
| | Particle | | | | Etching | Etching | Second magnetic layer | | Co | |
| | diameter | | Ra | | rate | time | | Ra | [μg/ | SNR |
| | [nm] | Rku | [nm] | Ion | [nm/s] | [second] | Rku | [nm] | surface] | [dB] |
| Ex. 1 | 7.2 | 5.8 | 0.33 | Ar | 0.02 | 6 | 3.0 | 0.25 | 40.1 | 11.4 |
| Ex. 2 | 7.2 | 5.8 | 0.33 | Kr | 0.02 | 6 | 2.8 | 0.24 | 3.9 | 11.6 |
| Ex. 3 | 7.2 | 5.8 | 0.33 | Xe | 0.02 | 6 | 2.7 | 0.25 | 3.3 | 11.7 |
| Ex. 4 | 7.2 | 5.8 | 0.33 | Xe | 0.02 | 8 | 2.6 | 0.25 | 3.2 | 11.4 |
| Ex. 5 | 7.2 | 5.8 | 0.33 | Xe | 0.02 | 10 | 2.5 | 0.25 | 2.9 | 11.1 |
| Comp. Ex. 1 | 7.2 | 5.8 | 0.33 | None | None | None | 5.1 | 0.31 | 121.9 | 10.8 |
| Comp. Ex. 2 | 7.2 | 5.8 | 0.33 | Ar | 0.02 | 4 | 4.1 | 0.28 | 110.5 | 11.1 |
| Comp. Ex. 3 | 7.2 | 5.8 | 0.33 | Kr | 0.02 | 3 | 4.1 | 0.26 | 98.6 | 11.1 |
| Comp. Ex. 4 | 7.2 | 5.8 | 0.33 | Xe | 0.02 | 2.5 | 4.1 | 0.26 | 91.0 | 11.4 |
| Comp. Ex. 5 | 7.2 | 5.8 | 0.33 | Ar | 0.02 | 12 | 2.4 | 0.25 | 2.1 | 9.6 |
| Comp. Ex. 6 | 7.2 | 5.8 | 0.33 | Kr | 0.02 | 10 | 2.4 | 0.22 | 2.0 | 9.8 |
| Comp. Ex. 7 | 7.2 | 5.8 | 0.33 | Xe | 0.02 | 9 | 2.4 | 0.20 | 2.2 | 9.2 |
| Comp. Ex. 8 | 8.6 | 4.9 | 0.3 | Ar | 0.02 | 6 | 2.8 | 0.23 | 2.5 | 9.5 |
| Comp. Ex. 9 | 8.6 | 4.9 | 0.3 | Kr | 0.02 | 6 | 2.5 | 0.22 | 1.6 | 9.6 |
| Comp. Ex. 10 | 8.6 | 4.9 | 0.3 | Xe | 0.02 | 6 | 2.2 | 0.22 | 1.9 | 10.3 |

As shown in Table 1, in the magnetic recording medium of each Example, the elution amount of Co was 40.1 μg/surface or less, and the SNR was 11.1 dB or more. In the magnetic recording medium of each Comparative Example, the elution amount of Co was 91.0 μg/surface or more, or the SNR was 10.3 dB or less. It was confirmed based on the results that the magnetic recording medium of each Example could achieve high electromagnetic conversion characteristics of the first magnetic layer while suppressing corrosion of the second magnetic layer, compared to the magnetic recording medium of each Comparative Example. The reason for this can be as follows. Specifically, unlike in the magnetic recording medium of each Comparative Example, the magnetic recording medium of each Example was that the Rku of the growth surface of the first magnetic layer was set to 5.8, and the Rku of the growth surface of the second magnetic layer was 2.5 or more and 3.0 or less. This can enhance the electromagnetic conversion characteristics of the first magnetic layer, and the corrosion resistance of the second magnetic layer.

In the magnetic recording medium of each Example, the Rku of the growth surface (upper surface) of the first magnetic layer is set to 5.8. Thus, the first magnetic layer can include magnetic particles having small particle diameters, i.e., micronized magnetic particles, and have enhanced electromagnetic conversion characteristics. The magnetic recording medium of each Example has enhanced electromagnetic conversion characteristics, and thus can have increased recording density.

In the magnetic recording medium of each Example unlike in the magnetic recording medium of each Comparative Example, the Rku of the growth surface of the first magnetic layer is set to 5.8, and the Rku of the growth surface of the second magnetic layer is set to be 2.5 or more and 3.0 or less. Thus, the magnetic recording medium of each Example has increased recording density, and enhanced corrosion resistance.

Also, the elution amount of Co of the magnetic recording medium decreased in the order of Examples 1 to 3. It was confirmed based on the results of Examples 1 to 3 that the effect of lowering the RKu of the second magnetic layer could be increased when Kr and Xe having an atomic weight that is greater than that of Ar, i.e., being heavier than Ar, were used as the inert gas for ion milling the surface of the magnetic film in the formation of the second magnetic layer, compared to when Ar was used as the inert gas for ion milling the surface of the magnetic film in the formation of the second magnetic layer.

Further, the elution amount of Co of the magnetic recording medium of each Example was smaller than the elution amount of Co of the magnetic recording media of Comparative Examples 1 to 4. Therefore, it was confirmed that the corrosion resistance of the magnetic recording medium of each Example could be greatly enhanced when the Rku of the growth surface of the second magnetic layer was 3.0 or less.

The elution amount of Co of the magnetic recording media of Comparative Examples 5 to 7 was smaller than the elution amount of Co of the magnetic recording media of Comparative Examples 1 to 4. However, the SNR of the magnetic recording media of Comparative Examples 5 to 7 was lower than that of the magnetic recording media of Comparative Examples 1 to 4, i.e., the magnetic recording media of Comparative Examples 5 to 7 could not achieve both satisfactory magnetic characteristics and satisfactory corrosion resistance. This is likely because the Rku of the second magnetic layer in the magnetic recording media of Comparative Examples 5 to 7 was excessively lowered, and thus the first magnetic layer was damaged and lowered in the magnetic characteristics.

Therefore, even if a heat-assisted recording method is used, the magnetic recording medium according to the present embodiment can enhance the corrosion resistance while increasing the recording density. Therefore, when used as a heat-assisted magnetic recording medium, the magnetic recording medium according to the present embodiment can stably exhibit a high surface recording density, i.e., when used in a magnetic storage apparatus, the magnetic recording medium according to the present embodiment can stably exhibit a high recording capacity.

According to one aspect of the present disclosure, it is possible to increase recording density and enhance corrosion resistance.

According to one aspect of the present disclosure, since the recording density of the magnetic recording medium can be increased, it is possible to provide a magnetic storage apparatus having an increased storage capacity. Further, according to another aspect of the present disclosure, since the Rku of the surface of the magnetic recording medium can be lowered, it is possible to reduce thin portions of the protective film which are readily scraped, thereby providing a magnetic storage apparatus having good corrosion resistance.

What is claimed is:

1. A magnetic recording medium, comprising:
a substrate;
a first magnetic layer that includes magnetic particles having an L1₀ structure and being (001)-oriented; and
a second magnetic layer that includes magnetic particles having an hcp structure and including at least Co and Pt,
the first magnetic layer being stacked over the substrate, and the second magnetic layer being stacked over the first magnetic layer, wherein
Rku of a growth surface of the first magnetic layer is 5 or more, and
Rku of a growth surface of the second magnetic layer is 2.5 or more and 4.0 or less.

2. The magnetic recording medium according to claim 1, wherein
a particle diameter of the magnetic particles included in the first magnetic layer is 10 nm or less.

3. A magnetic recording medium production method, comprising:
forming a first magnetic layer over a substrate with a growth surface being a (001) plane, a (111) plane, and an equivalent plane of the (111) plane, in which the first magnetic layer includes magnetic particles having an L1₀ structure and being (001)-oriented, and Rku of the growth surface is set to be 5 or more;
forming a magnetic film over the first magnetic layer, in which the magnetic film includes magnetic particles having an hcp structure and including at least Co and Pt; and
ion milling a surface of the magnetic film to form a second magnetic layer in which Rku is 2.5 or more and 4 or less.

4. The magnetic recording medium production method according to claim 3, wherein
the ion milling uses a noble gas having an atomic weight that is greater than an atomic weight of Ar.

5. A magnetic storage apparatus, comprising:
the magnetic recording medium of claim 1;
a magnetic recording medium driver configured to rotate the magnetic recording medium;
a magnetic head;
a magnetic head driver configured to move the magnetic head; and
a recording/reproducing signal processor.
